(19) United States
(12) Patent Application Publication
(10) Pub. No.: US 2022/0053397 A1
(43) Pub. Date: Feb. 17, 2022

(54) METHOD FOR HANDLING SECONDARY CELL GROUP FAILURE AND USER EQUIPMENT USING THE SAME

(71) Applicant: Industrial Technology Research Institute, Hsinchu (TW)

(72) Inventor: Nai-Lun Huang, Hsinchu County (TW)

(73) Assignee: Industrial Technology Research Institute, Hsinchu (TW)

(21) Appl. No.: 17/400,125

(22) Filed: Aug. 12, 2021

Related U.S. Application Data
(60) Provisional application No. 63/064,898, filed on Aug. 12, 2020.

(51) Int. Cl. H04W 36/30; H04W 36/08; H04W 36/00

(52) U.S. Cl. CPC H04W 36/305; H04W 36/00837; H04W 36/08

(57) ABSTRACT

Provided are a method for handling secondary cell group (SCG) failure and a user equipment (UE) using the same. The method is applied to the UE and includes the following steps. The UE is configured with a conditional PSCell change (CPC) configuration in which the CPC configuration includes at least one candidate target PSCell. In response to an occurrence of an SCG failure, a PSCell change for changing to the at least one candidate target PSCell is performed.

### CROSS-REFERENCE TO RELATED APPLICATION

This application claims the priority benefit of U.S. Provisional Application No. 63/064,898, filed on Aug. 12, 2020. The entirety of the above-mentioned patent application is hereby incorporated by reference herein and made a part of this specification.

### TECHNICAL FIELD

The disclosure relates to a method for handling secondary cell group failure and a user equipment using the same.

### BACKGROUND

With an increase in the demand for networks, specifications of communication systems are upgraded. Therefore, the 3rd generation partnership project (3GPP) has proposed a new generation mobile communication standard, 5th generation mobile networks (5G). In a 5G communication system, three types of communication application scenarios are defined, namely enhanced mobile broadband (eMBB), massive machine type communications (mMTC), and ultra-reliable and low latency communications (URLLC).

In the 5G communication system, a user equipment (UE) may adopt a dual connectivity (DC) architecture which may allow the UE to be connected to two nodes and use radio resources provided by different radio access technologies (RATs) (e.g. long term evolution (LTE) or new radio (NR)) at the same time. Specifically, the UE may be connected to a base station serving as a master node (MN) and a base station serving as a secondary node (SN). In the DC architecture, the UE may be connected to a master cell group (MCG) corresponding to the master node and a secondary cell group (SCG) corresponding to the secondary node. The MCG and the SCG may respectively include multiple service cells aggregating based on the carrier aggregation (CA) technology. The MCG may include a primary cell (PCell) and a secondary cell (SCell). The SCG may include a primary secondary cell (PSCell) and a secondary cell (SCell).

### SUMMARY

The disclosure relates to a method for handling secondary cell group (SCG) failure and a user equipment using the same.

An embodiment of the disclosure relates to a method for handling secondary cell group failure. The method is applied to a user equipment and includes, but not limited to, the following steps. The user equipment is configured with a conditional PSCell change (CPC) configuration. The CPC configuration includes at least one candidate target PSCell. In response to an occurrence of a secondary cell group failure, a PSCell change for changing to the at least one candidate target PSCell is performed.

An embodiment of the disclosure relates to a user equipment including, but not limited to, a transceiver and a processor. The transceiver is configured to receive and transmit a signal. The processor is coupled to the transceiver and is configured to execute the following steps. The user equipment is configured with a CPC configuration. The CPC configuration includes at least one candidate target PSCell. In response to an occurrence of a secondary cell group failure, a PSCell change for changing to the at least one candidate target PSCell is performed.

In order to make the aforementioned features of the disclosure comprehensible, embodiments accompanied with drawings are described in detail below.

### BRIEF DESCRIPTION OF THE DRAWINGS

The accompanying drawings are included to provide further understanding of the disclosure, and are incorporated in and constitute a part of this specification. The drawings illustrate embodiments of the disclosure and, together with the description, serve to explain the principles of the disclosure.

FIG. 1 is an exemplary flow chart of a secondary cell group failure information procedure.

FIG. 2 is a schematic diagram of a communication system according to an embodiment of the disclosure.

FIG. 3 is a block diagram of a user equipment according to an embodiment of the disclosure.

FIG. 4 is a flow chart of a method for handling secondary cell group failure according to an embodiment of the disclosure.

FIG. 5 is a flow chart of a method for handling secondary cell group failure according to an embodiment of the disclosure.

FIG. 6 is a flow chart of a method for handling secondary cell group failure according to an embodiment of the disclosure.

FIG. 7 is a flow chart of a method for handling secondary cell group failure according to an embodiment of the disclosure.

FIG. 8 is a flow chart of a method for handling secondary cell group failure according to an embodiment of the disclosure.

### DESCRIPTION OF THE EMBODIMENTS

In order to facilitate understanding of the aforementioned features and advantages of the disclosure, exemplary embodiments accompanied with drawings are described in detail below. It is to be understood that both the foregoing general description and the following detailed description are exemplary, and are intended to provide further explanation of the disclosure as claimed.

The term “user equipment” (UE) in the disclosure may be, for example, a mobile station (MS), an advanced mobile station (AMS), a server, a client, a desktop computer, a laptop computer, a network computer, a workstation, a personal digital assistant (PDA), a tablet personal computer (PC), a scanner, a telephone device, a pager, a camera, a television, a hand-held video game device, a music device, a wireless sensor, a cellphone, and the like. In some applications, a UE may be a fixed computer device operating in a mobile environment such as a bus, a train, an airplane, a boat, a car, and the like.

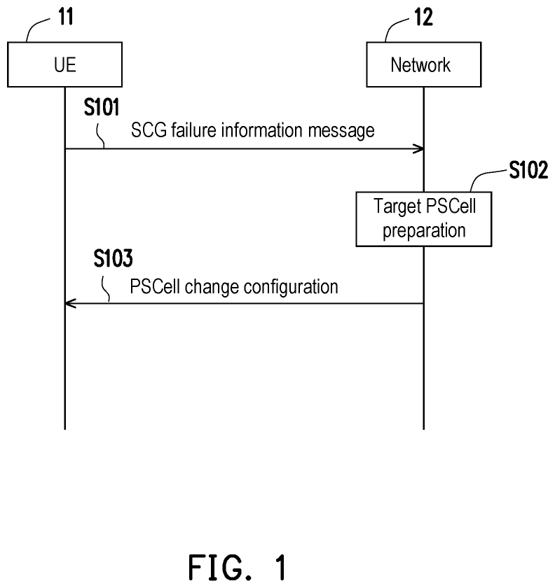

FIG. 1 is an exemplary flow chart of a secondary cell group failure information procedure. Referring to FIG. 1, when an SCG failure such as an SCG radio link failure (RLF) occurs, in step S101, a UE 11 transmits an SCG failure information message to a network 12. In response to receiving the SCG failure information message, the network 12 performs handling on the SCG failure information message. For example, in step S102, the network 12 performs an operation of target PSCell preparation to determine a target PSCell suitable for the UE 11. Next, in step S103, the network 12 returns a PSCell change configuration to the UE 11, to notify the UE 11 to switch to the target PSCell that is determined in step S102 by the network 12. Therefore, the SCG radio link failure is recovered.

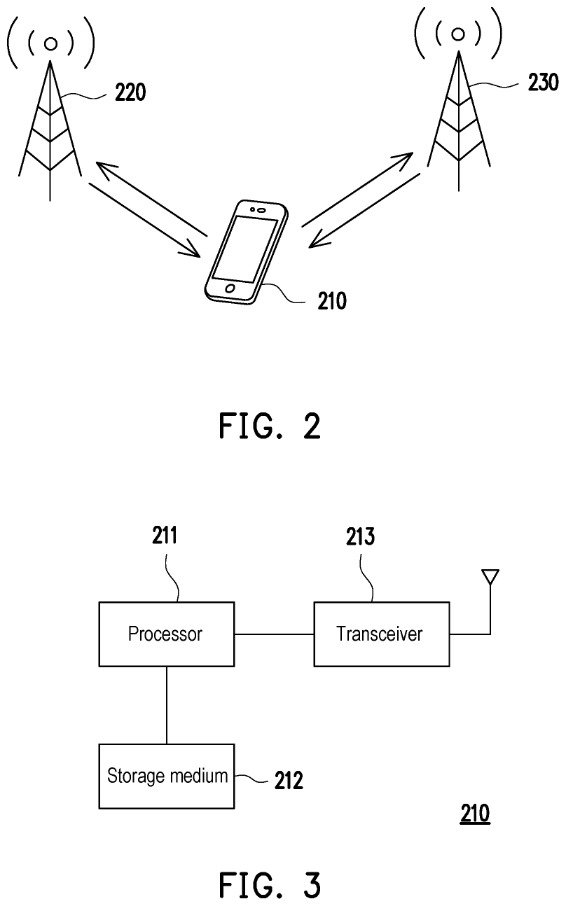

FIG. 2 is a schematic diagram of a communication system according to an embodiment of the disclosure. Referring to FIG. 2, a communication system 20 includes but not limited to a UE 210, a base station (BS) 220, and a BS 230. The BS 220 and the BS 230 may be implemented as a home evolved node B (HeNB), an eNB, a next generation node B (gNB), a base transceiver system (BTS), a relay, or a repeater, and the like.

The UE 210 may be connected to the BS 220 and the BS 230 through a dual connectivity (DC) technology. One of the BS 220 and the BS 230 may serve as a master node (MN), and the other of the BS 220 and the BS 230 may serve as a secondary node (SN).

FIG. 3 is a block diagram of a user equipment according to an embodiment of the disclosure. Referring to FIG. 3, the UE 210 may at least include, but not limited to, a processor 211, a storage medium 212, and a transceiver 213.

The processor 211 is, for example, a central processing unit (CPU), other programmable general-purpose or specific-purpose microprocessor, a digital signal processor (DSP), a programmable controller, an application specific integrated circuit (ASIC), a graphics processing unit (GPU), other similar element, or a combination of the above elements. The processor 211 is configured to execute a later-described method for handling secondary cell group failure.

The storage medium 212 is coupled to the processor 211 and is, for example, any type of fixed or mobile volatile memory or non-volatile memory, such as a random access memory (RAM), a read-only memory (ROM), a flash memory, a hard disk (HDD), a solid state drive (SSD), other similar element, or a combination of the above elements. The storage medium 212 stores multiple modules or programs to be accessed by the processor 211 so that the processor 211 may execute various communication functions of the UE 210.

The transceiver 213 is coupled to the processor 211. The transceiver 213 may receive a downlink (DL) signal and transmit an uplink (UL) signal. The transceiver 213 may execute operations such as low noise amplification (LNA), impedance matching, analog-to-digital conversion (ADC), digital-to-analog conversion (DAC), frequency mixing, up and down frequency conversion, filtration, amplification, and/or similar operations. The transceiver 213 may further include an antenna array, and the antenna array may include one or multiple antennas configured to transmit and receive an omnidirectional antenna beam or a directional antenna beam.

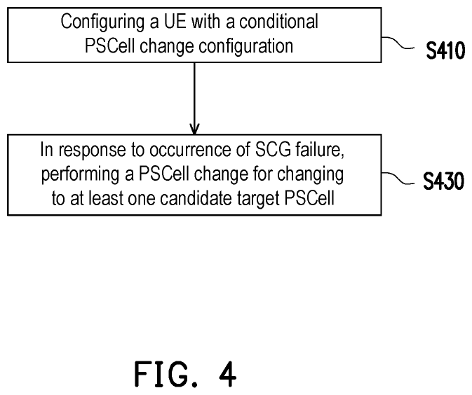

FIG. 4 is a flow chart of a method for handling secondary cell group failure according to an embodiment of the disclosure. Referring to FIG. 4, the method of the embodiment is applied to the UE 210 in FIG. 2 and FIG. 3. In the paragraphs below, first, the elements of the UE 210 are referred to for the description of the method of the embodiment. However, the process of the method may be adjusted according to actual needs and is thus not limited to the description below.

In step S410, the processor 211 of the UE 210 may configure the UE 210 with a conditional PSCell change configuration. The CPC configuration includes at least one candidate target PSCell. In an embodiment, the UE 210 may receive the CPC configuration from a network through the transceiver 213. After the UE 210 receives the CPC configuration, the CPC configuration may be stored in the storage medium 212.

In an embodiment, the UE 210 may receive the CPC configuration from the network, and the network may include a core network or a base station (e.g. the BS 220 or the BS 230). Note that according to the mobile communication standards of different generations, types and functions of equipment in the core network may vary, and the disclosure is not limited thereto. In an embodiment, the UE 210 may receive the CPC configuration by receiving a radio resource control (RRC) reconfiguration message. In an embodiment, the CPC configuration may include one or multiple candidate target PSCells.

In step S430, in response to an occurrence of an SCG failure, the processor 211 of the UE 210 may perform a PSCell change for changing to at least one candidate target PSCell. In an embodiment, the SCG failure may be an SCG radio link failure (RLF). In an embodiment, the SCG failure may include a failure of SCG reconfiguration with sync. In an embodiment, the SCG failure may be a CPC execution failure.

In an embodiment, the processor 211 of the UE 210 may detect the SCG RLF associated with a source PSCell. In an embodiment, the UE 210 may determine whether the SCG RLF has occurred based on expiration of a timer T310 defined by the 3GPP, whether RLC RETX_COUNT defined by the 3GPP exceeds a transmission limit, or detection of a random access issue. That is, causes of the occurrence of the SCG RLF may include not only a movement of a UE and a change in signal quality of a base station, but also network congestion or the like.

In an embodiment, when the UE 210 detects the occurrence of the SCG failure, it means that communication between the UE 210 and the PSCell fails. In an embodiment, in response to the occurrence of the SCG failure, the UE 210 may perform the PSCell change according to condition information. The UE 210 may evaluate whether a CPC execution condition in the CPC configuration, a threshold-based event different from the CPC execution condition, or a combination thereof is satisfied. Furthermore, the UE 210 may perform signal quality measurement on at least one candidate target PSCell in the CPC configuration and determine whether the condition information is satisfied according to a signal measurement parameter (e.g. reference signal received power (RSRP), reference signal received quality (RSRQ), and the like). In an embodiment, the UE 210 may perform signal quality measurement on all the candidate target PSCells in the CPC configuration. In response to the UE 210 determining that the condition information is satisfied, the UE 210 may perform the PSCell change to attempt to access a candidate target PSCell that satisfies the condition information, thereby handling the SCG failure.

In an embodiment, when the SCG failure is an SCG RLF, the UE 210 may recover an SCG radio link through the candidate target PSCell in the CPC configuration. In other words, in an embodiment, the CPC configuration may not only be used for a CPC designed based on a movement of a UE and a change in signal quality of the base station but also for handling of an SCG RLF. The causes of the occurrence of the SCG RLF may include not only a movement of a UE and a change in signal quality of a base station, but also network congestion or the like. In this case, by using the CPC configuration in handling the SCG RLF, the use of the CPC configuration may further be widened.

In an embodiment, the condition information determining whether to perform the PSCell change may include a CPC execution condition in the CPC configuration, a threshold-based event different from the CPC execution condition, or a combination thereof.

In an embodiment, the threshold-based event different from the CPC execution condition may include a common threshold-based event shared by all the at least one candidate target PSCell or a dedicated threshold-based event dedicated to each of the at least one candidate target PSCell. In other words, different candidate target PSCells may be configured to correspond to different dedicated threshold-based events. In addition, each candidate target PSCell may also correspond to the same common threshold-based event. In other words, different candidate target PSCells may correspond to the same common threshold-based event. For example, assuming that at least one candidate target PSCell includes a first candidate target PSCell and a second candidate target PSCell, the threshold-based event different from the CPC execution condition may be a common threshold-based event suitable for both the first candidate target PSCell and the second candidate target PSCell, or alternatively, the threshold-based event different from the CPC execution condition may include a first dedicated threshold-based event dedicated to the first candidate target PSCell and a second dedicated threshold-based event dedicated to the second candidate target PSCell.

In an embodiment, the common threshold-based event includes a first common threshold-based event configured along with the CPC configuration or a second common threshold-based event obtained by the UE 210 through a non-CPC configuration procedure. The non-CPC configuration procedure is, for example, a broadcast procedure. The second common threshold-based event may be criteria of a suitable cell, such as quality criteria or signal strength of the suitable cell.

In an embodiment, the condition information for recovery of the SCG failure may be the threshold-based event different from the CPC execution condition. When the UE 210 takes the threshold-based event different from the CPC execution condition as the condition information for recovery of the SCG failure, in response to the occurrence of the SCG failure, the UE 210 may stop evaluating the CPC execution condition in the CPC configuration.

In an embodiment, the condition information for recovery of the SCG failure may be the threshold-based event different from the CPC execution condition. When the UE 210 takes the threshold-based event different from the CPC execution condition as the condition information for recovery of the SCG failure, in response to the occurrence of the SCG failure, the UE 210 may stop evaluating the CPC execution condition in the CPC configuration but evaluate the threshold-based event different from the CPC execution condition. Next, when the threshold-based event is satisfied, the UE 210 may perform the PSCell change to attempt to access at least one candidate target PSCell that satisfies the condition.

In an embodiment, the condition information for recovery of the SCG failure may be the CPC execution condition in the CPC configuration. When the UE 210 takes the CPC execution condition in the CPC configuration as the condition information for recovery of the SCG failure, in response to the occurrence of the SCG failure, the UE 210 may continue evaluating the CPC execution condition. Next, when the CPC execution condition is satisfied, the UE 210 may perform the PSCell change to attempt to access at least one candidate target PSCell that satisfies the condition.

In an embodiment, the condition information for recovery of the SCG failure may be the CPC execution condition and the threshold-based event different from the CPC execution condition. When the UE 210 takes the threshold-based event and the CPC execution condition in the CPC configuration as the condition information for recovery of the SCG failure, in response to the occurrence of the SCG failure, the UE 210 may simultaneously evaluate the CPC execution condition and the threshold-based event. Next, when the CPC execution condition is satisfied or the threshold-based event is satisfied, the UE 210 may perform the PSCell change to attempt to access at least one candidate target PSCell that satisfies the condition.

Specifically, in the disclosure, the CPC execution condition in the CPC configuration may be, for example, defined by 3GPP TS 38.331. The threshold-based event may be criteria of a suitable cell, such as quality criteria or signal strength of the suitable cell. In an embodiment, the threshold-based event different from the CPC execution condition and the CPC execution condition may be simultaneously present in the CPC configuration. In response to the occurrence of the SCG failure, the UE 210 may evaluate whether the threshold-based event is satisfied, thereby determining whether to perform the PSCell change to attempt to recover the SCG failure.

In an embodiment, the threshold-based event different from the CPC execution condition may be configured according to a signal quality threshold value, a signal quality hysteresis parameter, or a maintenance time threshold value. For example, according to the threshold-based event, the UE 210 may determine whether a signal quality measurement parameter of the candidate target PSCell is greater than the signal quality threshold value. Or, according to the threshold-based event, the UE 210 may determine whether the signal quality measurement parameter of the candidate target PSCell is greater than a sum of the signal quality threshold value and the signal quality hysteresis parameter. Or, according to the threshold-based event, the UE 210 may determine whether the signal quality measurement parameter of the candidate target PSCell is continuously greater than the signal quality threshold value for more than the maintenance time threshold value. Or, according to the threshold-based event, the UE 210 may determine whether the signal quality measurement parameter of the candidate target PSCell is continuously greater than the sum of the signal quality threshold value and the signal quality hysteresis parameter for more than the maintenance time threshold value.

Different exemplary embodiments of recovering the SCG failure according to the candidate target PSCell in the CPC configuration are described below. To clearly describe the disclosure, the SCG failure is hereinafter regarded as an SCG RLF; however, the disclosure is not limited thereto.

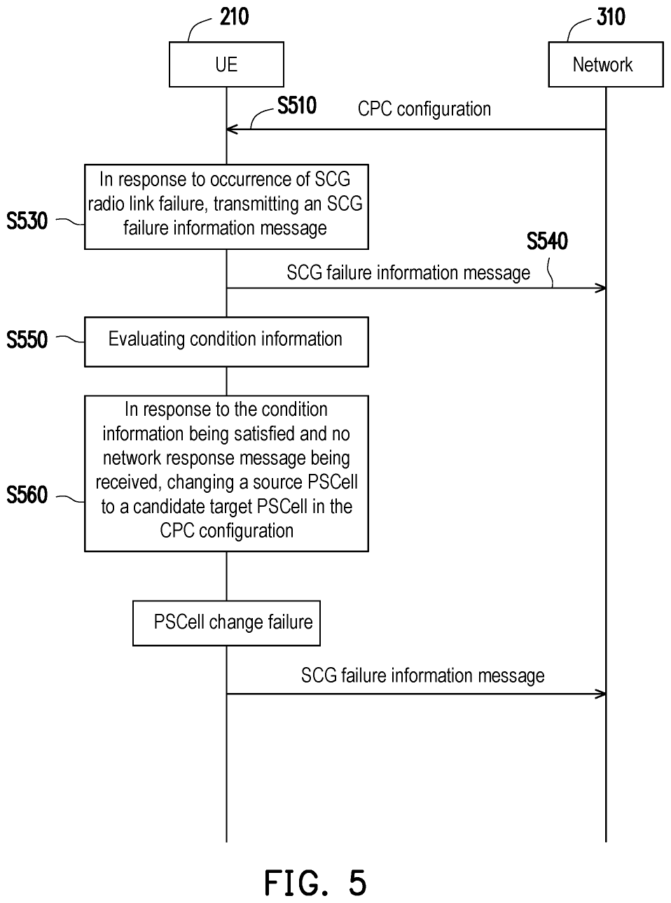

FIG. 5 is a flow chart of a method for handling secondary cell group failure according to an embodiment of the disclosure. Referring to FIG. 5, in step S510, the UE 210 may receive the CPC configuration from a network 310 and obtain at least one candidate target PSCell in the CPC configuration. The UE 210 detects an SCG RLF. In step S530, in response to the occurrence of the SCG RLF, the UE 210 transmits an SCG failure information message. In step S540, the UE 210 transmits the SCG failure information message to the network 310. Here, the SCG failure information message includes an indicator configured to indicate that the CPC configuration is configured. In step S550, the UE 210 evaluates the condition information.

In an embodiment, the UE 210 may be triggered in response to the occurrence of the SCG RLF to evaluate the condition information. Or, in an embodiment, the UE 210 may be triggered in response to receiving the CPC configuration to evaluate the condition information and continue evaluating the condition information in the CPC configuration after the occurrence of the SCG RLF.

In step S560, in response to the condition information being satisfied and no network response message being received, the UE 210 changes a source PSCell to at least one candidate target PSCell in the CPC configuration. That is, in an embodiment, before receiving a network response message corresponding to the SCG failure information message, in response to the condition information being satisfied, the UE 210 may change the source PSCell to the at least one candidate target PSCell in the CPC configuration. Therefore, delay in recovery of the SCG RLF may be shortened.

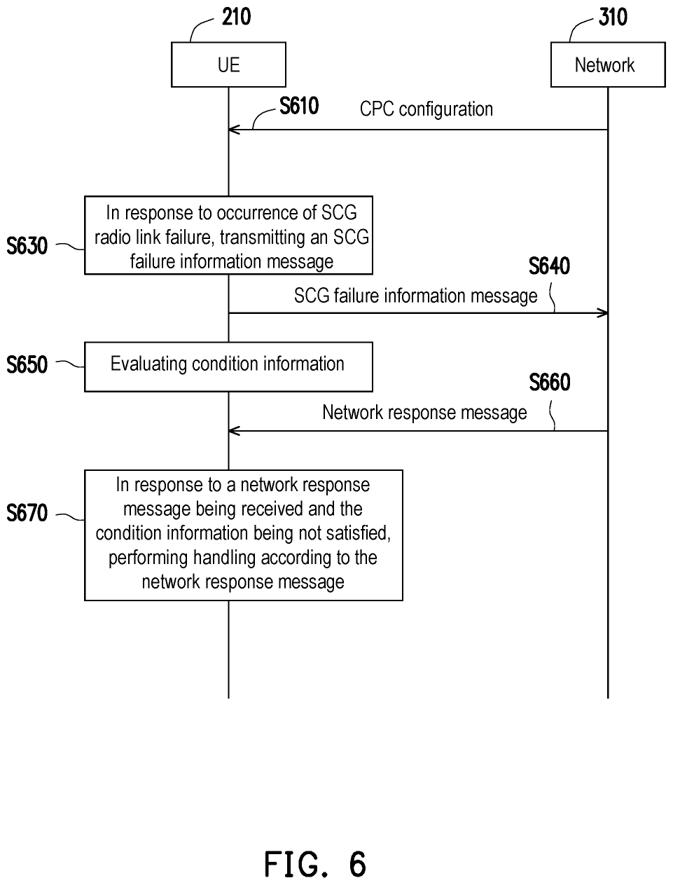

FIG. 6 is a flow chart of a method for handling secondary cell group failure according to an embodiment of the disclosure. In an embodiment, steps S610 to S650 are identical or similar to steps S510 to S550. Referring to FIG. 6, in step S610, the UE 210 may receive the CPC configuration from the network 310 and obtain at least one candidate target PSCell in the CPC configuration. The UE 210 detects an SCG RLF. In response to the occurrence of the SCG RLF, in step S640, the UE 210 transmits the SCG failure information message to the network 310. Here, the SCG failure information message includes the indicator configured to indicate that the CPC configuration is configured. In step S650, the UE 210 evaluates the condition information. In step S660, the UE 210 receives a network response message corresponding to the SCG failure information message. In step S670, in response to the network response message corresponding to the SCG failure information message being received and the condition information being not satisfied, the UE 210 may perform handling according to the network response message. For example, the UE 210 may change the source PSCell to a specific target PSCell indicated by the network response message.

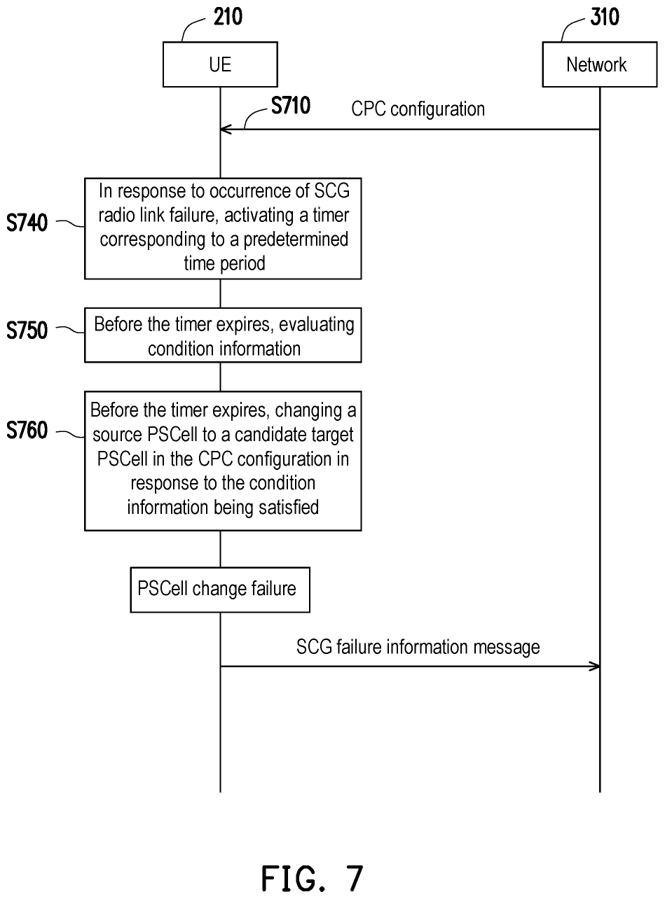

FIG. 7 is a flow chart of a method for handling secondary cell group failure according to an embodiment of the disclosure. Referring to FIG. 7, in step S710, the UE 210 may receive the CPC configuration from the network 310. The UE 210 detects an SCG RLF. In step S740, in response to detecting the occurrence of the SCG RLF, the UE 210 may activate a timer corresponding to a predetermined time period. In step S750, before the timer expires, the UE 210 may evaluate the condition information. In other words, the UE 210 may evaluate the CPC execution condition in the CPC configuration, the threshold-based event different from the CPC execution condition, or the combination thereof during the predetermined time period. In the embodiment of FIG. 7, in step S760, before the timer expires, the UE 210 may change the source PSCell to the candidate target PSCell in the CPC configuration in response to the condition information being satisfied. Therefore, if the PSCell change for changing the source PSCell to the candidate target PSCell in the CPC configuration is successfully performed, the UE 210 may recover the SCG RLF without transmitting any SCG failure information message.

In an embodiment, after steps S560 and S760, if the PSCell change fails, in response to failure of the PSCell change, the UE 210 may transmit the SCG failure information message to the network 310. The SCG failure information message may include an indicator configured to indicate that the PSCell change fails and execution failure information. In an embodiment, the execution failure information may include at least one candidate target PSCell the UE 210 fails in an attempt to access. Hence, in response to the SCG failure information message, the network 310 may perform an operation of target PSCell preparation and exclude the candidate target PSCell the UE 210 fails in an attempt to access according to the indicator and the execution failure information in the SCG failure information message, so as to determine a target PSCell more suitable for the UE 210.

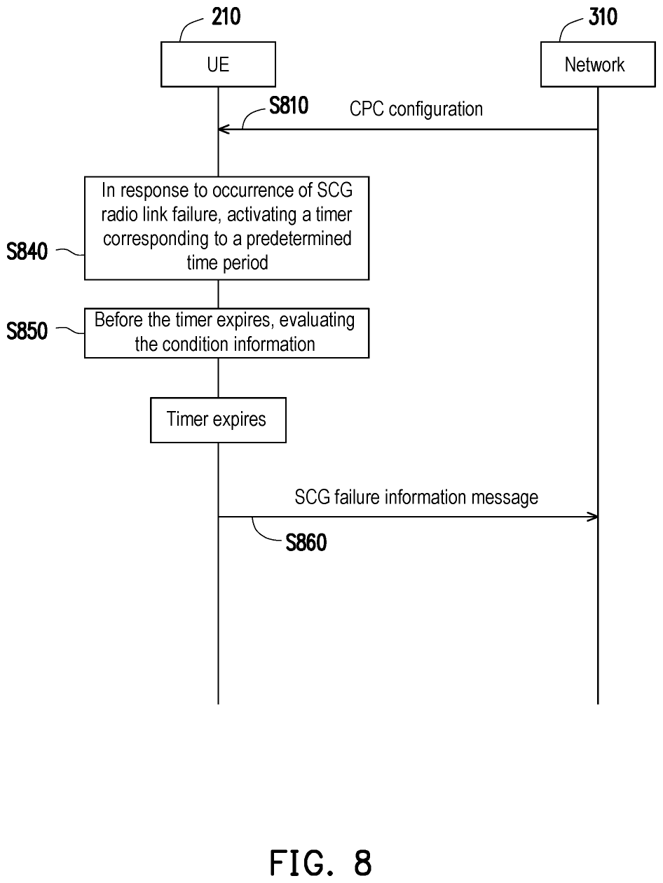

FIG. 8 is a flow chart of a method for handling secondary cell group failure according to an embodiment of the disclosure. Referring to FIG. 8, in step S810, the UE 210 may receive the CPC configuration from the network 310. The UE 210 detects an SCG RLF. In step S840, in response to the occurrence of the SCG RLF, the UE 210 may activate a timer corresponding to a predetermined time period. In step S850, before the timer expires, the UE 210 may evaluate the condition information. In the embodiment of FIG. 8, in step S860, in response to the timer expiring and the condition information being not satisfied, the UE 210 may transmit the SCG failure information message to the network 310. The SCG failure information message in step S860 may include the candidate target PSCell in the CPC configuration. In other words, when the UE 210 does not find the candidate target PSCell that satisfies the condition information within the predetermined time period, the UE 210 may transmit the SCG failure information message to the network 310 so that the network 310 may configure the UE 210 with a more suitable PSCell in subsequent operations by directly excluding the candidate target PSCell in the CPC configuration.

In summary of the above, in the embodiments of the disclosure, the CPC configuration may be used in SCG failure recovery. Accordingly, the network does not have to execute an operation related to target PSCell preparation in response to the SCG failure or spend time signaling to notify the UE of a configuration. In addition, it is not necessary for the UE to transmit the SCG failure information message to the network in response to the SCG failure. Even if the UE transmits the SCG failure information message, the SCG failure can be recovered in an attempt without taking time to wait for a response from the network. In the embodiments of the disclosure, a waste of signaling may be reduced, and a procedure delay may be avoided. Furthermore, the use of the CPC configuration is further widened.

Although the invention has been described in terms of embodiments as above, the embodiments are not intended to limit the invention. It will be apparent to those of ordinary skill in the art that some changes and modifications may be made without departing from the spirit and scope of the invention. Therefore, the scope of the invention shall be defined by the appended claims.

What is claimed is:

1. A method for handling secondary cell group (SCG) failure, the method being applied to a user equipment, the method comprising:
configuring the user equipment with a conditional PSCell change (CPC) configuration, wherein the CPC configuration comprises at least one candidate target PSCell; and
in response to an occurrence of the SCG failure, performing a PSCell change for changing to the at least one candidate target PSCell.

2. The method for handling secondary cell group failure according to claim 1, wherein the SCG failure comprises an SCG radio link failure (RLF), a failure of SCG reconfiguration with sync, or a CPC execution failure.

3. The method for handling secondary cell group failure according to claim 1, wherein performing the PSCell change for changing to the at least one candidate target PSCell in response to the occurrence of the SCG failure comprises:
in response to the occurrence of the SCG failure, performing the PSCell change according to condition information, wherein the condition information comprises a CPC execution condition in the CPC configuration, a threshold-based event different from the CPC execution condition, or a combination thereof.

4. The method for handling secondary cell group failure according to claim 3, wherein the threshold-based event comprises a common threshold-based event shared by all the at least one candidate target PSCell or a dedicated threshold-based event dedicated to each of the at least one candidate target PSCell.

5. The method for handling secondary cell group failure according to claim 4, wherein the common threshold-based event comprises a first common threshold-based event configured along with the CPC configuration or a second common threshold-based event obtained by the user equipment through a non-CPC configuration procedure.

6. The method for handling secondary cell group failure according to claim 1, further comprising:
in response to the occurrence of the SCG failure, transmitting an SCG failure information message to a network, wherein the SCG failure information message comprises an indicator configured to indicate that the CPC configuration is configured.

7. The method for handling secondary cell group failure according to claim 6, wherein performing the PSCell change for changing to the at least one candidate target PSCell comprises:
evaluating condition information; and
before receiving a network response message corresponding to the SCG failure information message, in response to the condition information being satisfied, performing the PSCell change for changing to the at least one candidate target PSCell.

8. The method for handling secondary cell group failure according to claim 7, further comprising:
in response to the network response message corresponding to the SCG failure information message being received and the condition information being not satisfied, performing handling according to the network response message.

9. The method for handling secondary cell group failure according to claim 1, further comprising:
in response to a failure of the PSCell change, transmitting an SCG failure information message to a network, wherein the SCG failure information message comprises an indicator configured to indicate that the PSCell change fails and execution failure information.

10. The method for handling secondary cell group failure according to claim 9, wherein the execution failure information comprises the at least one candidate target PSCell in the CPC configuration the user equipment fails in an attempt to access.

11. The method for handling secondary cell group failure according to claim 1, wherein performing the PSCell change for changing to the at least one candidate target PSCell comprises:
before a timer expires, evaluating condition information; and
in response to the timer expiring and the condition information being not satisfied, transmitting an SCG failure information message to a network, wherein the SCG failure information message comprises the at least one candidate target PSCell in the CPC configuration.

12. The method for handling secondary cell group failure according to claim 11, wherein performing the PSCell change for changing to the at least one candidate target PSCell comprises:
before the timer expires, in response to the condition information being satisfied, performing the PSCell change for changing to the at least one candidate target PSCell.

13. A user equipment, comprising:
a transceiver configured to receive a signal; and
a processor coupled to the transceiver and configured to:
configure the user equipment with a conditional PSCell change (CPC) configuration, wherein the CPC configuration comprises at least one candidate target PSCell; and
in response to an occurrence of a secondary cell group (SCG) failure, perform a PSCell change for changing to the at least one candidate target PSCell.

14. The user equipment according to claim 13, wherein the SCG failure comprises an SCG radio link failure (RLF), a failure of SCG reconfiguration with sync, or a CPC execution failure.

15. The user equipment according to claim 13, wherein the processor is configured to:
in response to the occurrence of the SCG failure, perform the PSCell change according to condition information, wherein the condition information comprises a CPC execution condition in the CPC configuration, a threshold-based event different from the CPC execution condition, or a combination thereof.

16. The user equipment according to claim 15, wherein the threshold-based event comprises a common threshold-based event shared by all the at least one candidate target PSCell or a dedicated threshold-based event dedicated to each of the at least one candidate target PSCell.

17. The user equipment according to claim 16, wherein the common threshold-based event comprises a first common threshold-based event configured along with the CPC configuration or a second common threshold-based event obtained by the user equipment through a non-CPC configuration procedure.

18. The user equipment according to claim 13, wherein the processor is configured to:
in response to the occurrence of the SCG failure, transmit an SCG failure information message to a network, wherein the SCG failure information message comprises an indicator configured to indicate that the CPC configuration is configured.

19. The user equipment according to claim 18, wherein the processor is configured to:
evaluate condition information; and
before receiving a network response message corresponding to the SCG failure information message, in response to the condition information being satisfied, perform the PSCell change for changing to the at least one candidate target PSCell.

20. The user equipment according to claim 19, wherein the processor is configured to:
in response to the network response message corresponding to the SCG failure information message being received and the condition information being not satisfied, perform handling according to the network response message.

21. The user equipment according to claim 13, wherein the processor is configured to:
in response to a failure of the PSCell change, transmit an SCG failure information message to a network, wherein the SCG failure information message comprises an indicator configured to indicate that the PSCell change fails and execution failure information.

22. The user equipment according to claim 21, wherein the execution failure information comprises the at least one candidate target PSCell in the CPC configuration the user equipment fails in an attempt to access.

23. The user equipment according to claim 13, wherein the processor is configured to:
before a timer expires, evaluate condition information; and
in response to the timer expiring and the condition information being not satisfied, transmit an SCG failure information message to a network, wherein the SCG failure information message comprises the at least one candidate target PSCell in the CPC configuration.

24. The user equipment according to claim 23, wherein the processor is configured to:
before the timer expires, in response to the condition information being satisfied, perform the PSCell change for changing to the at least one candidate target PSCell.
